(19) United States
(12) Patent Application Publication
(10) Pub. No.: US 2025/0130090 A1
(43) Pub. Date: Apr. 24, 2025

(54) SELF-READING WATER METER

(71) Applicant: Braden DeWhite, San Luis Obispo, CA (US)

(72) Inventor: Braden DeWhite, San Luis Obispo, CA (US)

(21) Appl. No.: 18/493,556

(22) Filed: Oct. 24, 2023

(51) Int. Cl. G01F 23/02

(52) U.S. Cl. CPC G01F 23/02

(57) ABSTRACT

The device is used to check whether a plant in a container needs water. An outer tube extends through the container soil. The bottom of the outer tube has a cap for preventing soil from entering the tube. An inner tube having an outside diameter less than the inside diameter of the outer tube extends through the outer tube to the bottom of the container. Water rises to a height in the outer and inner tubes varying by the amount of water in the container. The user covers the top of the inner tube with his or her finger while removing the inner tube from the outer tube. The water cannot flow from the inner tube because of the finger sealing the tube. With the inner tube visible, the user can know if the soil is watered sufficiently based on the inner tube's water level.

### BACKGROUND

### 1. Field

Self-reading water meter primarily for indoor gardening.

### 3. General Background and State of the Art

Growing plants in pots and other small containers is a convenient way to garden, especially indoors. Container gardening lets people locate decorative plants and vegetables in available spaces and in proper sunlight or artificial light. Indoor containers receive no rain, and infrequent rain outdoors may cause the soil to dry out. Indoor containers often lack drainage holes on the bottom or sides of the container to prevent water from leaking onto furniture, shelves, or floors. But if a container plant needs water, and too much water is added to the container, the container can overflow and damage furniture, shelves, or floors. By “added water,” applicant also means fertilizer or other substances added to H₂O. Some outdoor containers drain excess rain or added water through openings at the container's base, and those containers can be positioned where the excess water does not drain into undesirable areas.

Positioning outdoor containers shielded from rain may be desirable because heavy rain can leach fertilizer from the container soil, and overflowing containers can stain concrete patios and leave mud around the container. Indoor plants have similar issues except overwatering instead of heavy rain causes similar results.

There are self-watering planters. A common form has a lower or water section, an upper or soil section containing soil or other growing medium, and a filter or other porous material between the upper and lower sections to prevent the soil from entering the lower section. A tube extends through the soil section and filter into the water section for adding water to the water section.

Instead of a lower section that only contains water, the lower section may have materials such as sand, gravel, pebbles, or other solid material, which can fill with water in the spaces between the material.

Some containers may have no separate lower or water section but are filled with soil or growing medium from their bottom to the top of the soil. Container planting soil is usually less dense than outdoor soil so water flows through it more easily. Soil closer to the bottom of the container, therefore, usually is wetter than soil above the bottom.

### SUMMARY

An outer tube is long enough to reach the bottom of a container. The outer tube may have a cap with openings at its bottom to block soil or debris from entering the tube. The cap also can provide a surface to allow the outer tube to be pushed through soil. An empty inner tube has an outside diameter less than the inside diameter of the outer tube. With the top of the inner tube open and exposed to the atmosphere, the inner tube mounts in the outer tube and extends to the bottom the outer tube.

Water in the container rises up through the inner tube to the level of the water in the container. The user closes the top of the inner tube with a finger or other object so that when the inner tube is removed from the container, the water level in the inner tube doesn't change and approximates the container's water level. The user can determine whether to add water through the outer tube or inner tube to the soil based on the inner tube's water level. If water is added, the user can repeat the test to determine the water level in the container.

This device also can work for containers without separate soil and water sections because the soil near the bottom of watered indoor plants collects water, which flows into the outer and inner tubes.

The inner tube may have indicia corresponding to water levels in the container.

### BRIEF DESCRIPTION OF THE DRAWINGS

FIG. 1 is a front view of an outer tube, an inner tube, and a bottom cap for the outer tube.

FIG. 2 is a front view of an inner tube mounted within an outer tube.

FIG. 3 is a sectional view of a container with a plant and the inner and outer tubes in soil.

FIG. 4 is a sectional view of a container with a plant and the soil and saturated soil with water separated.

FIG. 5 is a sectional view of a container with a plant and the soil and saturated soil with water separated and the inner tube removed from the outer tube.

### DETAILED DESCRIPTION

Containers for growing plants can have soil from the bottom of the container to a top level. As used in this description, “soil” includes conventional soil and other growing media including compost, peat moss, bark, perlite, vermiculite, sand, other materials, and combinations of these materials that support the plant roots.

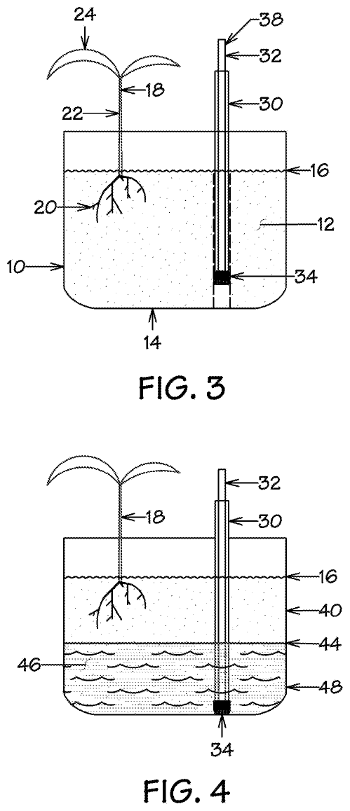

Container 10 (FIG. 3) may be of many materials. The container may be considered to have a first and a second space. The first space 40 is above second space 48. In FIG. 4, the first space contains soil, and the second space contains water. In FIG. 4, the second space extends from the bottom 34 of the container to the bottom of the first space 48 (i.e., top of the water to the bottom of soil 46). FIG. 4 shows filter or porous divider 44 that may be secured to the inside wall of the container to hold the soil above the second space. Soil 46 extends above the filter, and plant 18 is planted below surface 16 in the soil. The plant includes roots 20, stem 22 and leaves 24 in FIG. 3. It may contain flowers, buds, fruit, and other items (not shown)

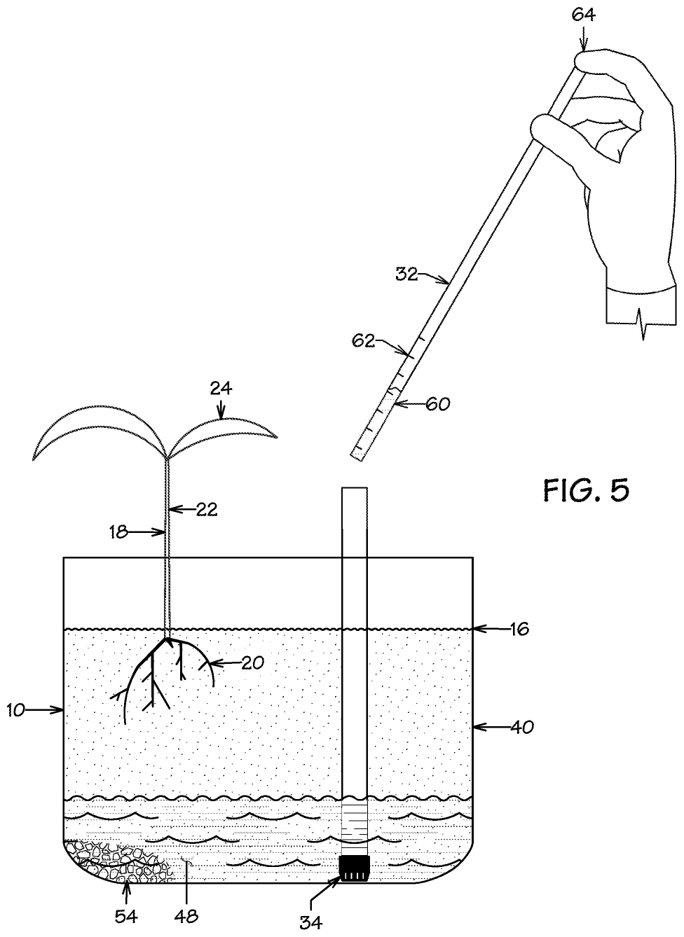

Water in second space 48 is shown as a reservoir in FIGS. 4 and 5. Objects such as pebbles, gravel, or other material 54 fill second space 48 in FIG. 5. The objects may avoid needing a filter.

The first and second spaces merge in FIG. 3 and contain soil. When the soil is watered, the water naturally flows downward such that after the container receives water, soil near the bottom of the container becomes wetter than soil near the top.

Outer tube 30 extends through the soil near base 14 of the container. The outer tube may be cylindrical, but shapes other than cylindrical can be used especially for decoration. Glass, plastic, or metal are possible materials. The two former materials are transparent, a potential advantage. FIG. 3 shows inner tube 32 is longer than the outer tube so when the inner tube is positioned in FIG. 3, a short section 38 of the inner tube extends out of the outer tube. A user can grip the short section to pull the inner tube from the outer tube.

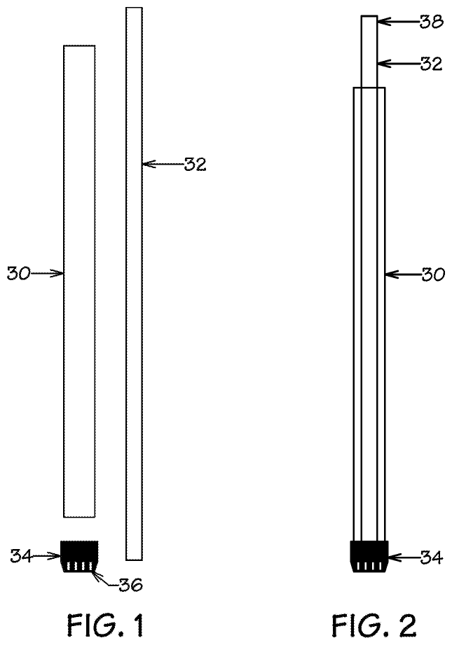

The bottom of the outer tube receives bottom cap 34, which has holes or slots 36 (see FIG. 1) that let water enter through the bottom of the outer tube. The cap may be pointed to assist also lets the outer tube be pushed through the soil. FIG. 3 shows the tube and cap pushing through soil 12.

Inner tube 32 has an outer diameter less than the inner diameter of outer tube 30 (FIG. 3) so the inner tube can fit and slide within the outer tube. The inner tube also may be glass, plastic, or metal. A transparent inner tube, e.g., glass or plastic, is beneficial.

The application uses “diameter” to refer to cylindrical and non-cylindrical shapes. If the outer diameter of outer tube 30 is not cylindrical, the inner tube's “outer diameter” must be of a size and shape that fits within the outer tube.

Water is added to reservoir 48 (FIG. 4) or to soil 12 (FIG. 3) through outer tube 30 and cap 34 (FIG. 4), through an opening in the side of the container, or through watering soil 46 or 12 at its surface.

If the second space contains sand, gravel, pebbles, or other solid material, 54 (FIG. 5), outer tube 30 may be positioned in the second space before adding the material and soil to the container.

After water is added to container 10 and is allowed to settle, inner tube 32 is inserted through outer tube 30. The inner tube could have been inserted before water was added. The water level in the inner tube rises to the water level in the container.

The inner tube may be long enough to extend above the top of the outer tube at 38. When a user covers the top of inner tube 32 tightly with finger 64 and removes the inner tube from outer tube 30 (FIG. 5), the water level 60 in the inner tube does not change. By looking through the transparent inner tube, the user can tell the water level in the container. Optional indicia 62 on the inner tube gives the user feedback of the water level. If the need for more water is indicated, the user can add water through one or both tubes or to the soil.

The description is illustrative, not limiting and is for example only. Although this application shows and describes examples, those having ordinary skill in the art will find it apparent they can make changes, modifications or alterations. Many examples involve specific combinations of method acts or system elements, but those acts and those elements may be combined in other ways to meet the same goals. Acts, elements, and features discussed only with one embodiment are not intended to be excluded from a similar role in other embodiments.

“Plurality” means two or more. A “set” of items may include one or more of such items. The terms “comprising,” “including,” “carrying,” “having,” “containing,” “involving,” and similar words in the written description or the claims are open-ended, i.e., each means, “including but not limited to.” Only the transitional phrases “consisting of” and “consisting essentially of” are closed or semi-closed transitional phrases regarding claims. The ordinal terms like “first,” “second,” “third,” etc., in the claims don't by themselves connote any priority, precedence, or order of one claim element over another or the temporal order in which acts of a method are performed. Instead, they merely are labels to distinguish one claim element having a certain name from another element having the same name (but for the ordinal term's use). Alternatives like “or” include one or any combination of the listed items.

I claim:

1. A device for determining the water level of a container for a plant in which the container has a first space at the bottom of the container capable of holding water, a second space above and separated from the first space capable of holding a growing medium, the device comprising:
an outer tube having top, a bottom and an inside diameter extending through the second space and the first space,
an inner tube having top, a bottom, and an outside diameter less than the inside diameter of the outer tube, the inner tube extending through the top of the outer tube into the first space.

2. The device for determining the water level of a container of claim 1 further comprising a cap on the bottom of the outer tube, the cap having at least one opening for allowing water to flow into the bottom of the outer tube.

3. The device for determining the water level of a container of claim 1 wherein the inner tube is insertable and removeable from the outer tube.

4. The device for determining the water level of a container of claim 1 wherein the inside diameter of the inner tube is small enough that it can be sealed by a person's finger.

5. A method for determining the amount of water in a container for plants, the container having a bottom, the method comprising mounting an outer tube having a top and a bottom and the outer tube's bottom being positioned near the bottom of the container, mounting an inner tube inside the outer tube, the inner tube having a top and bottom, the bottom of the inner tube extending adjacent the bottom of the outer tube, sealing the top of the inner tube, and removing the inner tube from the outer tube.
